(19) United States
(12) Patent Application Publication
(10) Pub. No.: US 2012/0210258 A1
(43) Pub. Date: Aug. 16, 2012

(54) COMPOSITIONAL DASHBOARDS WITH PROCESSOR COMPONENTS

(75) Inventors: Evgueni N. Bykov, Kenmore, WA (US); Ashvinkumar J. Sanghvi, Sammamish, WA (US)

(73) Assignee: MICROSOFT CORPORATION, Redmond, WA (US)

(21) Appl. No.: 13/026,189

(22) Filed: Feb. 11, 2011

(51) Int. Cl. G06F 3/048

(52) U.S. Cl. 715/764

(57) ABSTRACT

A dashboard can be composed of pre-defined data provider, presentation, and processor components. The data provider component acquires data from a source, and the presentation component visualizes data. The processor component enhances the data for actionable usability by various means (e.g., data aggregation, filtering, projections, wave shaping, anomaly detection, and combination . . . ).

### BACKGROUND

The present information era is characterized by an ability to provide and access data from numerous sources. Global proliferation of increasingly smaller and less expensive processor-based devices and components thereof in combination with large-scale network availability and growing bandwidth continues to expand the pool of data exponentially. However, people have a limited ability to comprehend and extract useful information from large quantities of data.

Dashboards are effective tool in helping people make sense of data and complex information. A dashboard is a user interface (UI) designed to present data and complex information in an easily comprehensible manner, for example to enable decisions to be made based thereon. Information can be visualized in a graphical format, perhaps organized around particular goals and objectives, to enable performance information to be identified quickly. Furthermore, a dashboard can include a number of graphical widgets or panels that can display related or otherwise relevant information. Dashboards, or portions thereof, can also be interactive enabling end-users to acquire additional and/or different information than originally presented. As a result, dashboards allow decisions to be made, and action taken, more expeditiously than would otherwise be possible without the tool.

Although dashboards can be stand-alone applications, often they form part of a specific end-to-end solution. For example, a computer-system management application can include a dashboard user-interface to present results of monitoring operations. Furthermore, such dashboards are frequently developed as single monolithic applications incorporating both data access and presentation. In other words, data access and presentation code are tightly coupled.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to compositional dashboards with processor components. Predefined components including data provider, processor, and presentation components can be composed to generate a dashboard. The data provider component acquires data from a source and the presentation component visualizes data. The processor component is configured to enhance data for actionable usability by various means (e.g., data aggregation, filtering, projections, wave shaping, anomaly detection, combination . . . ). Furthermore, dashboards can be composed declaratively by simply identifying distinct predefined components and the relationship between the components. Still further yet, the predefined components can be platform independent thereby enabling cross-platform utilization.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a dashboard composition system.

FIG. 2A is a block diagram of exemplary unit components.

FIG. 2B is a block diagram of exemplary composite components.

FIGS. 3A-B are block diagrams of exemplary dashboard compositions.

FIGS. 4A-B are block diagrams of exemplary dashboard compositions.

FIG. 5 is a block diagram of an exemplary dashboard composition that employs dependent presentation components.

FIG. 6 is a block diagram of an exemplary dashboard composition where processor component logic is moved to a data source.

FIG. 7 is a flow chart diagram of a method of dashboard composition.

FIG. 8 is a flow chart diagram of a method of processing data.

FIG. 9 is a flow chart diagram of a method of processing data.

FIG. 10 is a schematic block diagram illustrating a suitable operating environment for aspects of the subject disclosure.

### DETAILED DESCRIPTION

Visualizing large amounts of data continues to be a long-standing problem. Dashboards address this problem. However, conventional dashboards break down with respect to presenting relevant information as the amount of data scales to high levels. Consider the computer-system management space, for example, where there is a need to visualize a lot of management information in a simple user interface, such as a dashboard. Currently, the volume of data being monitored from a single console is exploding. For example, there can be thousands of servers each hosting hundreds of virtual machines, and all of the related data needs to be visualized through one user-interface. To address this issue, pre-processing of data can be employed to increase the density and usefulness of visualized data.

Details below are generally directed toward compositional dashboards with processor components. More particularly, a dashboard can be composed from a plurality of distinct predefined components including data provider, presentation, and processor components defined by individuals with respective expertise. The data provider component acquires data from a source and the presentation component visualizes data. The processor component is configured to enhance data to be displayed to improving usability of the data with respect to initiating appropriate action, for instance. By way of example, data can be aggregated, filtered, or combined in interesting ways to aid an end-user in interpreting the data. Furthermore, a dashboard can be composed by declaratively specifying a composition including such predefined components without requiring implementation code to be written, compiled, or installed. Still further yet, the predefined components can be platform independent thus allowing dashboards to be created that operate across multiple platforms.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

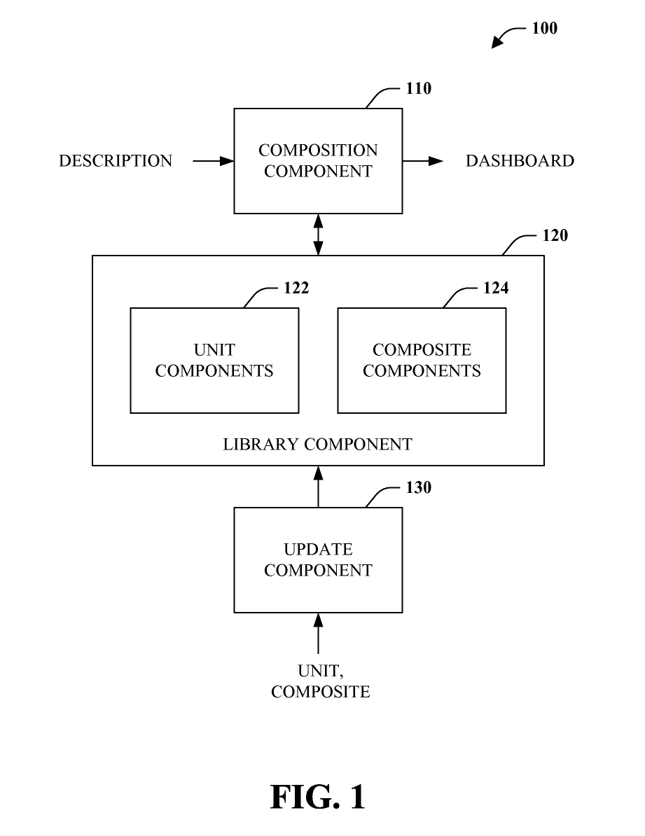

Referring initially to FIG. 1, a dashboard composition system 100 is illustrated. Included with the dashboard composition system 100 are a composition component 110, a library component 120 (e.g., sub-system), and an update component 130 (e.g., sub-system). The composition component 110 is configured to receive a description of a dashboard to be created and output an implementation of the dashboard. The dashboard can be described in terms of a composition of distinct predefined components provided by the library component 120. Furthermore, the update component 130 is configured to update the library with new predefined components to extend the types of dashboards that can be created.

In accordance with one embodiment, the dashboard description can be provided in terms of a declaration. For example, a declarative programming language (e.g., eXtensible Markup Language) can be employed to enable specification of what dashboard is desired rather than how to create the dashboard. A graphical user interface (UI) could also be employed, for instance as part of a dashboard design application (not shown), to further aid specification by providing a layer of abstraction between a dashboard designer and the declaration format. In any event, a dashboard designer need not be concerned with writing implementation code as well as compilation and installation thereof.

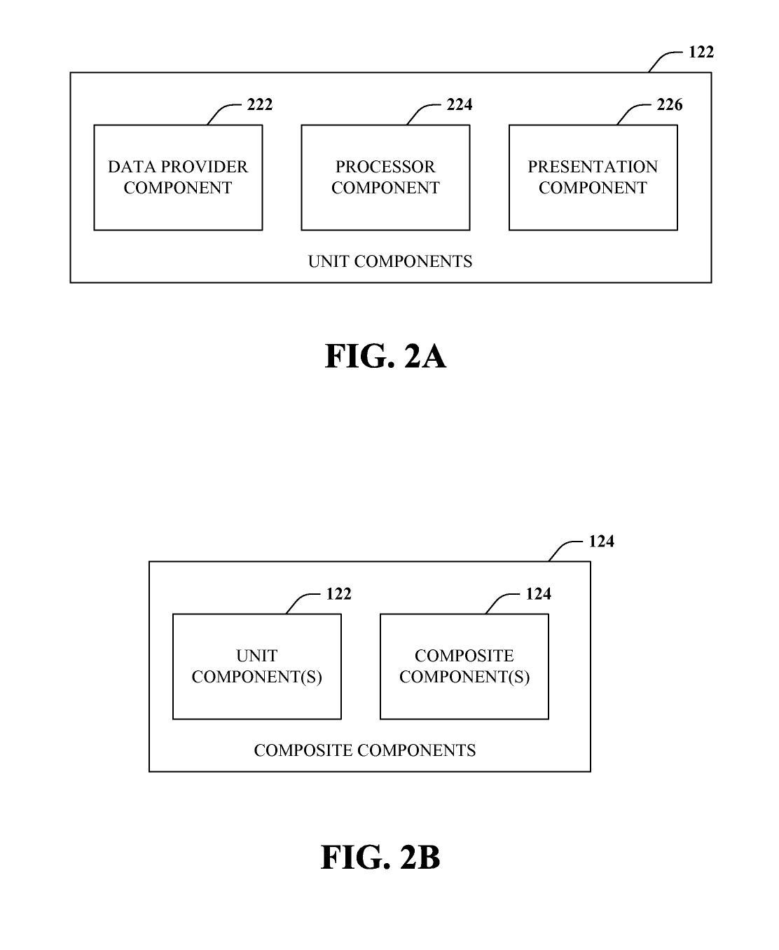

The library component 120 is configured to store elements of composition, or in other words, dashboard components. As shown, the library component 120 can include two types of components—unit components 122 and composite components 124. The unit components 122 correspond to rudimentary, or atomic, dashboard building blocks. The composite components 124 correspond to a combination of unit components 122 and/or composite components 124. Turning attention to FIG. 2A, exemplary unit components 122 are depicted. Here, three kinds of unit components 122 are illustrated, namely data provider component 222, processor component 224, and presentation component 226. A data provider component 222 is configured to acquire data from a source for use by a dashboard. A presentation component 226 is configured to provide a user interface that enables display of, and interaction with, data supplied by a data provider component 222, for instance. A processor component 224 is configured to enhance data for actionable usability in various manners. By way of example and not limitation, a processor component 224 can correspond, or include functionality, to count, compute a moving average, compute a differential, perform integration over time, aggregate a collection (e.g., average, median, percentile of, standard deviation . . . ), perform wave shaping (e.g., map 0-30 to 1, 30-60 to 2, and 60-100 to 3), perform self-tuning threshold (e.g., analyze a time series over a repeated cycle and automatically generate a normal envelope or threshold), detect anomalies (e.g., study a large set of members for a particular key performance indicator and detect outliers), count anomalies, determine rate of anomalies, perform compound counting (e.g., misery index=unemployment percentage+increase in percentage below poverty line+inflation rate*5), computing top “N,” perform a diversity computation (e.g., analyze many sets and for each set find the distribution of some indicator and then identify the sets with the most different distributions from the norm), or join, or aggregate, data from multiple sources. In accordance with one embodiment, domain specific data reduction and enhancement functionality can be employed. In sum, the processor component 224 is configured to perform pre-processing of data to improve usefulness. Consequently, a dashboard can present more valuable information than would otherwise be possible without the processor component 224.

As a more concrete example, instead of presenting raw transaction error events from billions of applications running on millions of machines, a processor component 224 can collect an event stream from every source, compute a running count, and automatically generate a normal range for applications of a particular category. A presentation component 226 can then flag out-of-range instances in red. Furthermore, the processor component 224 can compute the percentage of instances of red applications in a category, generate a normal range, and flag the categories that are outside that band. As a result, a graphical user interface need only show a few categories that need attention. Selection and drill down can show the instances that have a problem, further drill down can show graphs of these errors, and yet further drill down can show the actual events.

FIG. 2B illustrates an exemplary composite component 124. The composite component 124 can include one or more unit components 122. As described previously, a unit component 122 can correspond to a data provider component 222, a processor component 224, or a presentation component 226. Furthermore, the composite component 124 can include other composite components 124. In other words, the composite component 124 can be recursively defined to include other composite components 124 including a combination of unit components and/or composite components. In this manner, larger compositions can be created more easily utilizing composite components 124 than solely unit components 122.

Returning to FIG. 1, the update component 130 is configured to enable additional unit components 122 and/or composite components to be included in the library component 120. For example, an individual could produce a new processor component that can be added to the library component 120 for subsequent use by way of the update component 130. Furthermore, third-party developers could provide components free or for a fee that can be made available for use in composing a dashboard by way of the update component 130.

Furthermore, in accordance with one embodiment, the predefined dashboard components (e.g., data provide, processor, presentation, composite . . . ) need to be pre-installed on a particular machine to compose and/or utilize a dashboard. Rather, if a composite dashboard is specified with respect to a particular component for which it does not have code, such code can be dynamically fetched from an external source such as a web server, for instance.

Among other benefits, the dashboard composition system 100 enables creation of a dashboard that incorporates the knowledge and skill of many professionals. More particularly, an individual may know how to generate one type of component such as a presentation component to visualize data but have limited or no knowledge regarding data acquisition and processing. Similarly, another individual may have an understanding of how to extract data from a particular source, but lack the skill to produce a high-quality presentation or processing component. Furthermore, an individual may have solely domain expertise without any knowledge regarding how to best acquire, process, and present data. The dashboard composition system 100 remedies such issues by enabling an individual to exploit the expertise of many specialists, or in other words, experts, for example in data acquisition, processing, and/or processing to create a dashboard. All that needs to be done is to describe a desired dashboard in terms of particular predefined components.

Stated another way, the composition system 100 includes a late bound composition aspect. A domain expert who understands a particular usage scenario (e.g., package tracking application) can declaratively compose a dashboard purpose build for the domain from components previously defined/designed/composed by experts who better understand some data source (e.g., SQL operational database), some processing or enhancement techniques (e.g., anomaly detection), and presentation techniques (e.g., heat charts).

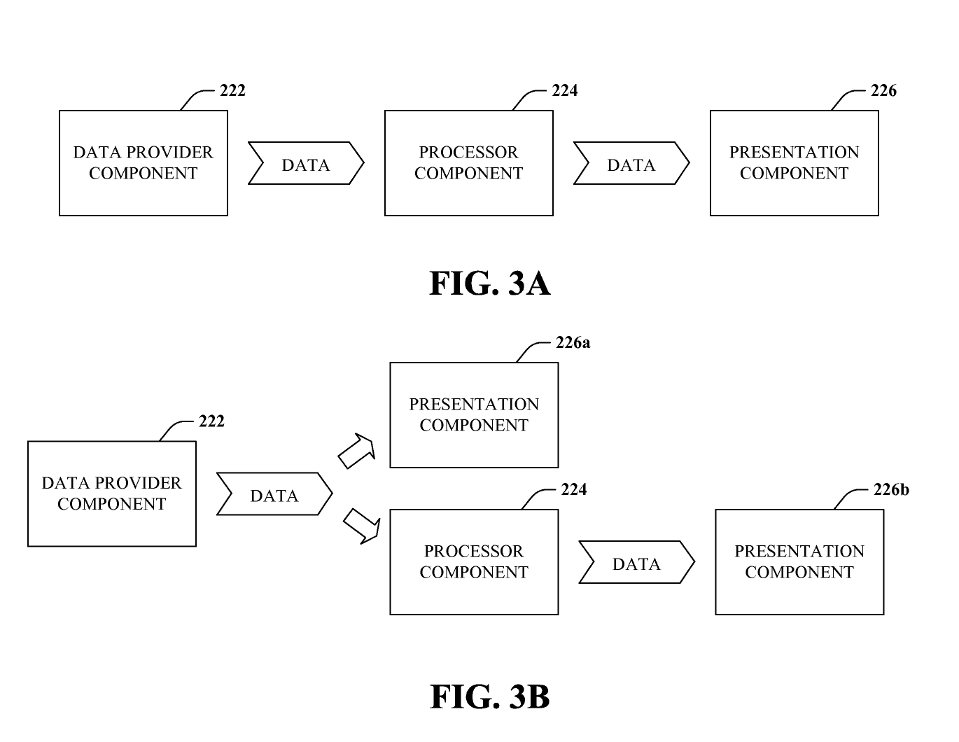

FIGS. 3-6 depict exemplary dashboard compositions to facilitate clarity and understanding with respect to aspects of this disclosure. Of course, such compositions describe but a few possible compositions. Many other combinations and permutations of components are possible and contemplated. Accordingly, the exemplary dashboard compositions of FIGS. 3-6 are not meant to limit the scope of the claimed subject matter thereto.

For purposes of clarity and understanding, the compositions are described solely in terms of a combination of unit components, namely a number of data provider, processor, and presentation components. Composite compositions are also contemplated. However, for the sake of simplicity the exemplary compositions are described with respect to unit compositions. Upon reading the below description, it will be clear to one of skill in the art as to how to extend the examples to include composite compositions.

In addition, it is assumed that data can be easily communicated and understood by each compositional component (e.g., data provider, processor, presentation). In one embodiment, a common representation of data (e.g., abstract data model) can be utilized to facilitate communication between the components. As a result, a processor component 224 can by injected between a data provider component 222 and a presentation component 226. However, the processor component 224 could change the shape of data or adopt a specific interface, if required, by data consuming components.

FIG. 3A illustrates an exemplary dashboard including a data provider component 222, processor component 224, and presentation component 226. The data provider component 222 can acquire data from a particular source and provide the data to the processor component 224, which can enhance the data in accordance with a specific mathematical function, for example, to improve data density and usability. The presentation component 226 can then acquire the enhanced data from the processor component and display the data in an easily comprehensible form (e.g., graph, chart, heat map . . . ). For instance, the data provider component 222 could acquire events corresponding to website accesses and failures. The processor component 224 could compute a failure rate by determining the number of failures over time divided total number of accesses. This computed failure rate could then be presented in a dashboard, as opposed to numerous access and failure events.

FIG. 3B illustrates an exemplary dashboard composition including multiple presentation components 226. Data provider component 222 can acquire data from a source, which can then be made accessible to a first presentation component 226a and processor component 224. The first presentation component 226a can display the raw data from the data provider component 222. The processor component can enhance the data set in accordance with some useful computation and provide the enhanced data set to the second presentation component 226b that displays the enhanced data. For example, the processor component 224 can include prediction logic over data such that the first presentation component 226a provides current data and the second presentation component 226b includes predicted data derived from the current data.

Often users desire to configure dashboards to view an aggregate as well as details. The processor component 224 can provide aggregation functionality. As will be described further herein, dashboards can be interactive. In this case, a pane (e.g., a portion of a dashboard window) can show aggregates (e.g., pie chart) from which a slice can be selected which then in the presentation component 226a causes a filter to be employed to view raw data. More concretely, a detail pane can be produced by the presentation component 226a that delivers a view of error messages while an aggregate pane provided by the presentation component 226 can display a pie chart by error type. Once someone selects a particular error type, the detail pain will provide those types of messages. The processor component 224, however, counts up messages by type and provides such data as a parameter to the presentation component 226b to drive a pie chart graphic

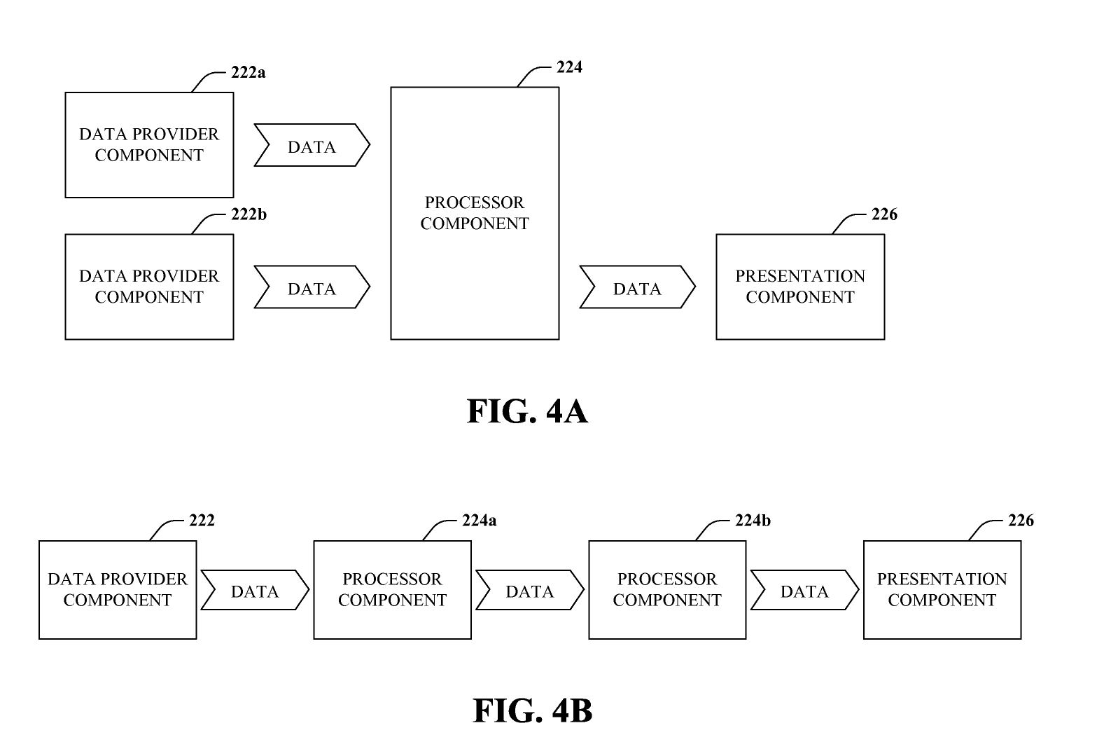

FIG. 4A depicts a dashboard composition including multiple data provider components. Here, a first data provider component 222a and a second data provider component 222b supply data from different sources. Processor component 224 can perform an operation over the collected data to produce an enhanced data set that can subsequently be displayed by presentation component 226. By way of example and not limitation, the data provider components 222a and 222b can provide information regarding a computer system including central processor utilization and disk input/output. The processor component 224 can produce a compound key performance indicator (KPI) for display by the presentation component 226. For instance, the data can be used to determine a computer operating state, including satisfactory (e.g., everything is fine), caution (e.g., something may be wrong), or unsatisfactory (e.g., something is wrong), which can be visualized with different colors corresponding to the state by the presentation component 226 (e.g., green, yellow, red).

FIG. 4B illustrates a dashboard composition including multiple processor components 224. Data provider component 222 provides data from a source, which is accessed by a first processor component 224a. After the first processor component 224a performs a data reduction operation, the enhanced data is provided to the second processor component 224b, which performs further reduction prior to display by presentation component 226. In other words, there is a chain of processing prior to presentation. For instance, the first processor component 224a can count the occurrences of a condition over time and the second processor component 224b can predict the occurrence of the condition in the future as a function of the count.

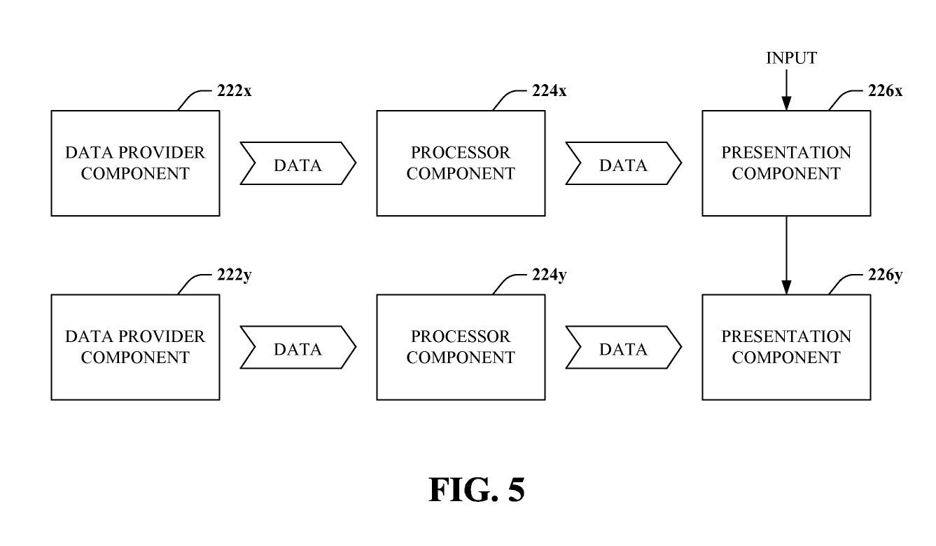

FIG. 5 depicts an exemplary dashboard composition including dependent presentation components 226. Similar to FIG. 3A, the composition includes data provider component 222x, processor component 224x and presentation component 226x, wherein the processor component 224x performs one or more operations on data supplied by the data provider component 222x, and the presentation component 226x visualizes results of the processor component 224x. However, the presentation component 226x is not limited to presenting data, but rather can be interactive. Accordingly, input can be acquired from a dashboard end-user. A second presentation component 226y can depend on data presented by a first presentation component 226x as well as acquired input. In other words, the data displayed by the second presentation component 226y varies as a function of the first presentation component 226x. Furthermore, the second presentation component 226y can also depend on data provided by a second processor component 224y and a second data provider component 222y. By way of example, the dependent, second presentation component 226y can provide a key performance indicator (KPI) for a particular server and the first presentation component 226x can identify the top-five performing servers in particular data center. Upon selection of one of the top-five servers with respect to the first presentation component 226x (e.g., clicking), the dependent, second presentation component 226y can display the key performance indicator for the selected server.

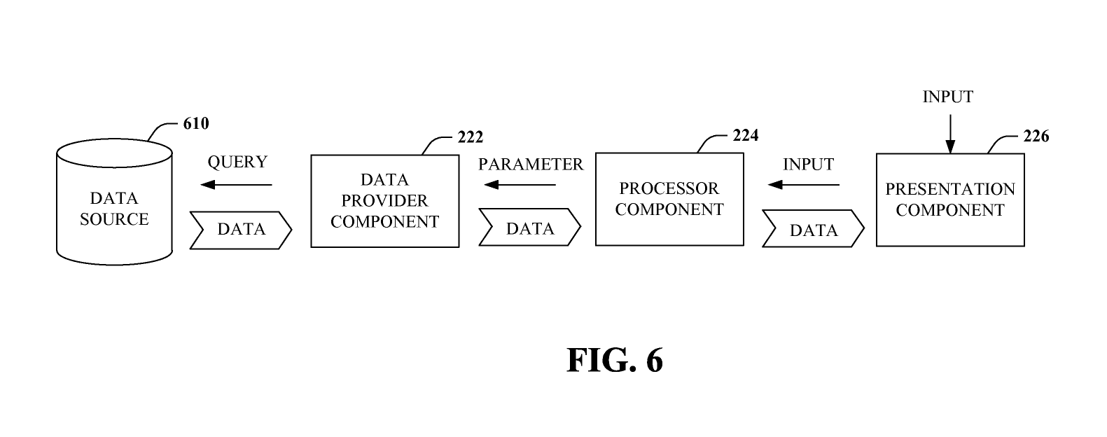

FIG. 6 shows an alternate composition embodiment. Previously described exemplary compositions included a processor component 224 that enhances data acquired from the data provider component 222 prior to supplying the enhanced data to the presentation component 226. However, the claimed subject matter is not limited thereto. Additionally or alternatively, logic performed by a processor component 224 can be pushed down to a data source 610 to achieve computational efficiencies. By way of example and not limitation, an enhancement can correspond to a data set reduction at the data source 610 such that less data is transmitted between compositional components. More particularly, the processor component 224 can provide a parameter, or argument, to the data provider component 222 that influences a query supplied by the data provider component 222 to the data source 610. The parameter enables the processor component 224 to apply enhancement logic at the data provider component 222 such that the amount of data transmitted from the data source 610 to the data provider component 222 and presentation component 226 is reduced. In other words, the processor component 224 can apply reduction logic to a database view by influencing a data provider component query. Still further yet, it is to be appreciated that the processor component 224 can be impacted by end-user input received through an interactive dashboard or pane thereof generated by presentation component 226. For instance, the input can specify selection of particular data of interest which could correspond to a filter over a data set which can be pushed from the processor component 224 to the data provider component 222 and subsequent augment the query provided by the data provider component 222 to the data source 610.

Once a dashboard is created, including compositions as described above, it can be distributed for use by others. By way of example and not limitation, a server management product can separate out infrastructure from domain specific knowledge. For instance, the management product can include infrastructure for monitoring server activity independent of a domain. On top of that, management packs can be distributed to monitor particular types of data stores (e.g., SQL, Exchange . . . ). Further, a management pack can be completely declarative about what to collect, how to collect, how to display, etc. Now the management pack can be expanded to include dashboards and more specifically dashboards that include processor components, among others. Accordingly, users can acquire a management pack, download the management pack onto their management servers, and suddenly start to see new user-interface behavior specific to the technology that they want to manage and/or the environment they want to manage. For example, a management pack may display the same type of information about relational database users. Now, a dashboard can be created to manage large farms of relational databases over a hundred servers, for example, including a processor component that aggregates information over the databases. For example, the dashboard can display the overall state and top ten servers that are behaving oddly, which will not be very useful to a person that is monitoring five servers.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, a processor component 224 could employ such mechanisms infer or predict further results.

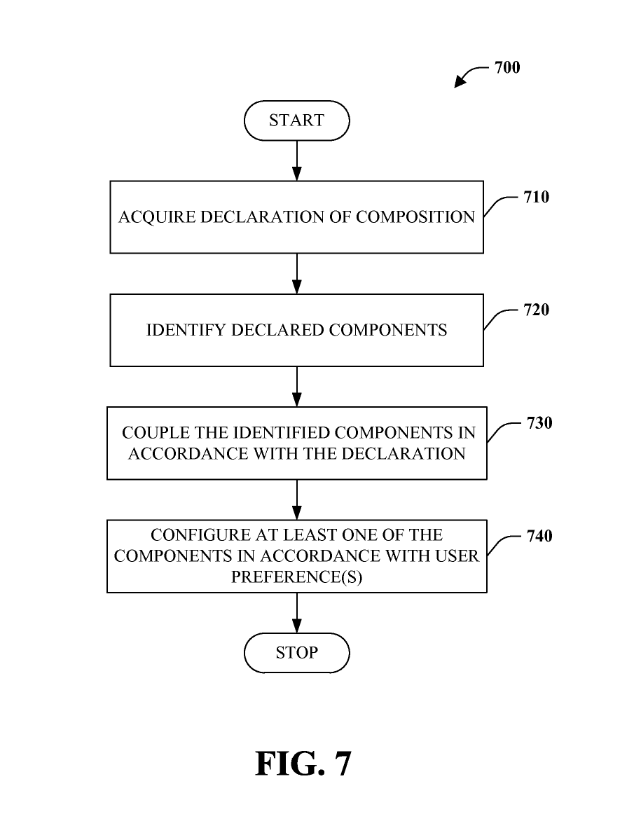

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 7, illustrates a method of dashboard composition 700. At reference numeral 710, a declaration of composition is acquired, for example as specified with a declarative programming language such as XML (eXtensible Markup Language). At numeral 720, declared components are identified from the declaration such as data provider components, processor components, and presentation components. At reference 730, the identified components are coupled in accordance with the declaration. For example, the data provider component is coupled to a processor component, which is coupled to a presentation component. Moreover, it should be appreciated that the components are loosely coupled rather than tightly coupled. In other words, the components are not inextricably bound, as is often the case with special built user interfaces and/or monolithic dashboards. At numeral 740, at least one of the components is configured in accordance with one or more user preferences. In other words, end-users can configure compositions to their liking in ways not considered during original dashboard composition. For example, a presentation component can be configured to present data in a different visual format.

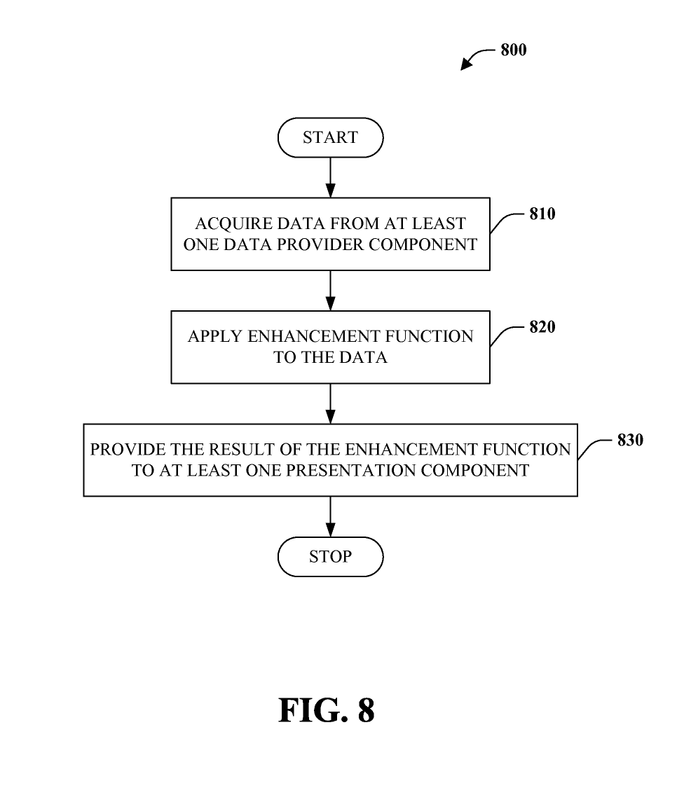

FIG. 8 depicts a method of data processing 800 that can be performed with respect to a dashboard data. At reference numeral 810, data is received, retrieved or otherwise obtained or acquired from at least one data provider component that supplies data from a data source. At numeral 820, at least one enhancement function is applied to the data supplied by the data provider component or other means, for instance, to improve the usefulness of the data. For example, aggregation functions (e.g., count, average, minimum, maximum . . . ) can be applied. Of course, many other enhancement functions of the same or increase complexity can also be employed (e.g., compound counter, wave shaping, anomaly detection, self-tuning thresholding . . . ). At reference numeral 830, the result(s) of the enhancement function is provided to at least one presentation component for use within an interactive dashboard user interface.

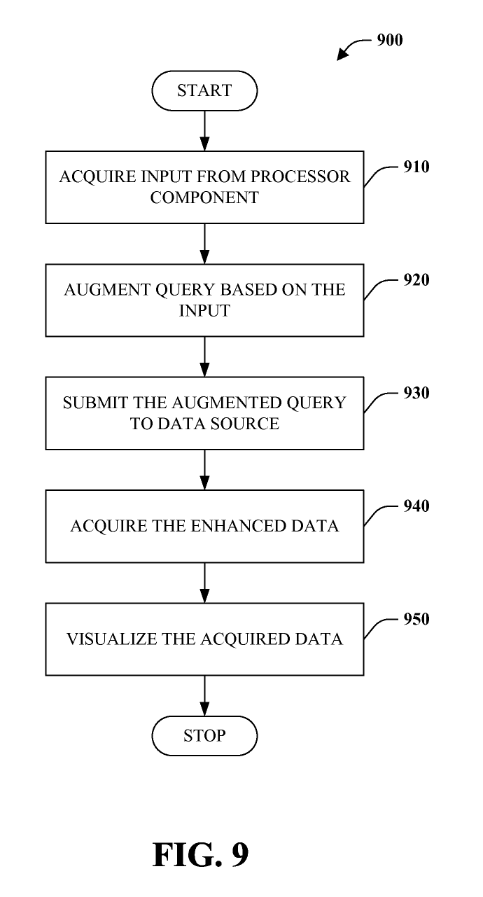

FIG. 9 is a flow chart diagram of a method of data processing 900. At reference numeral 910, input is received, retrieved, or otherwise obtained or acquired from a processor component, wherein the input specifies an enhancement function (e.g., aggregation, filtering, projections, wave shaping, anomaly detection, combination . . . ). At numeral 920, an initial query is augmented based on the input. At reference 930, the augmented query is submitted for processing by a data source. In response, an enhanced data set is acquired at 940 corresponding to the result of execution of the augmented query. At reference 950, the acquired data, corresponding to enhanced data, is visualized within a dashboard or portion thereof (e.g. pane).

By way of example and not limitation, consider an initial query specifying acquisition of a stream of events indicative of server access successes and failures over some time period. Based on input provided by the processor component for instance, the initial query can be augmented such that the query computes a failure average and returns that value rather than a more voluminous stream of success and failure events. Consequently, computational efficiencies can be achieved since a lesser amount of data is transmitted between a data source, data provider, and visualizer. By contrast, fetching larger quantities of data and subsequently filtering the data is less efficient.

What follows is additional detail regarding one particular implementation. The description is not meant to limit the disclosure or subject claims but rather to provide further details regarding one manner of implementing particular aspects of the disclosure. Those of skill in the art, upon reading the subject disclosure, will appreciate that there are many different ways to implement the particular aspects and other functionality.

The dashboard composition system 100 provides a generic composition framework that allows users to “glue” (compose) together different components and composite components. The framework supports composition of both user-interface and non-user interface components. While there could be a number of components glued together, a component chain can end at concrete unit components (e.g., Textbox control component, database query component . . . ).

Dashboard compositions can be specified with respect to a declaration of composition. The following provides an exemplary XML (eXtensible Markup Language) declaration:

<Component TypeId=“StackPanel”>

<Parameter Name=“Child”>

<Component TypeId=“Edit”>

<Target>$Target/propertyA$</Target>

</Component>
<Component TypeId=“Edit”>

<Target>$Target/ propertyB$</Target>

</Component>
<Component TypeId=“Button” />

</Parameter>

“Component” has a “Parameter” sub-node, which can define the data shape expected to be passed.

ComponentType ID=“AnotherComposition”>

<Parameters>

<Parameter Name=“Parameter1” Type=“String” />
<Parameter Name=“SelectedText” Type=“String”

BindingDirection=“Both” />

</Parameters>

“Parameter” defines binding for components properties:

<Component Id=“EventView”>
<Parameter Id=“Scope”>SystemCenter.SqlDB </Parameter>

In this case, the property “Scope” of component “EventView” is set to text “SystemCenter.Sq1 DB.” Frequently though, parameters are not static but are bound to other elements such us query result.

A data provider component 222 is a component (a.k.a. query component) that is configured to return data from a store. The result can be returned in an abstract data model in a form of either “IDataObject” or “IEnumerable<IDataObject>.” The “IDataObject” interface defines access for a given instance of an object, where an “IDataObject” implements, or is of type, “IDataType.”

The combination of an abstract data model, component composition, and parameter binding provides an ability to post-process data returned by a data provider and injection of processor components into a composition chain without modifying a data provider or presentation component code or interfaces. If necessary, however, processor component could also change the shape of the data or adopt a specific interface required by consuming components.

A notification mechanism built into a composite component parameter can define processor-component invocation logic as well as serve as a presentation observation mechanism. In the current implementation, “IDataObject” implements “INotifypropertyChanged” interface that allows supporting system (e.g., Windows Presentation Foundation, Silverlight™ . . . ) bindings to exercise the described logic upon notification that data has changed.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

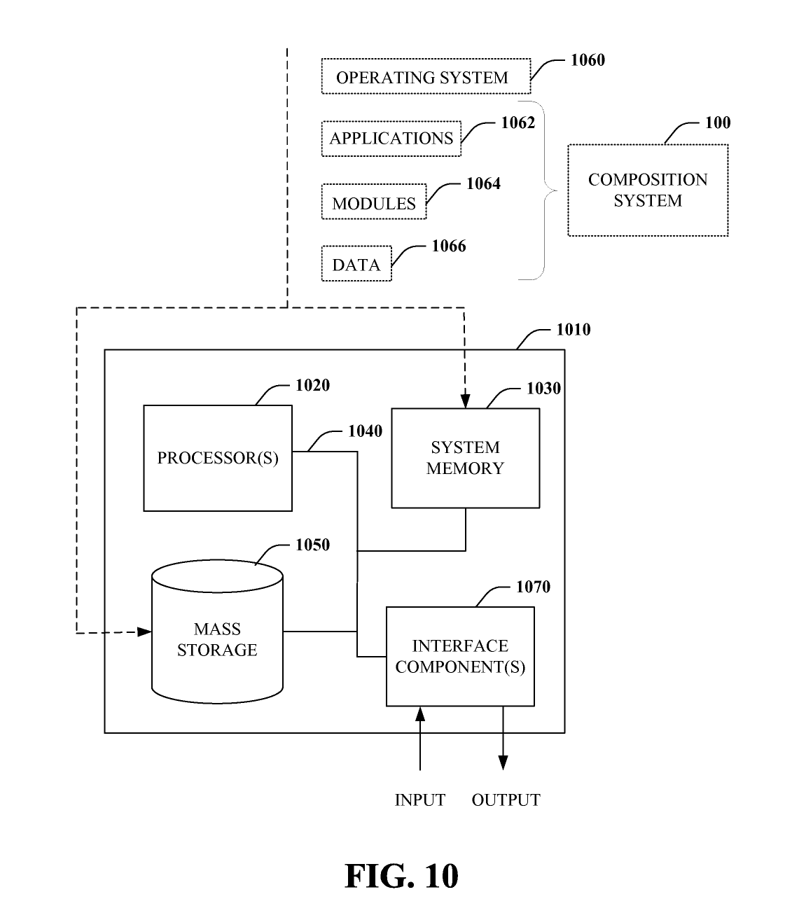

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer 1010 or computing device (e.g., desktop, laptop, server, hand-held, programmable consumer or industrial electronics, set-top box, game system . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, dashboard composition system 100, or portions thereof, can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the dashboard composition system 100 and/or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims

What is claimed is:

1. A method, comprising:
employing at least one processor configured to execute computer-executable instructions stored in memory to perform the following acts:
composing a dashboard from pre-defined data provider, presentation, and processor components, wherein the data provider component acquires data, the presentation component visualizes data, and the processor component enhances data.

2. The method of claim 1, composing the dashboard from a composition declaration.

3. The method of claim 2, further comprising fetching at least one of the data provider, processor, or presentation components from an external source.

4. The method of claim 1, distributing the dashboard for employment in a particular domain.

5. The method of claim 1, composing the dashboard with at least one processor component that that provides domain specific enhancement functionality.

6. The method of claim 1, composing the dashboard including a first predefined component that depends on user input to a second predefined component.

7. The method of claim 1, composing the dashboard from a composite composition including one or more unit compositions including the data provider, presentation, and processor components.

8. The method of claim 1 further comprises updating a library of dashboard components with an additional processor component.

9. The method of claim 1 further comprises configuring the dashboard as a function of one or more end-user preferences.

10. A system that facilitates dashboard composition, comprising:
a processor coupled to a memory, the processor configured to execute the following computer-executable components stored in the memory:
a composition component configured to compose a platform independent dashboard from pre-defined data provider, processor, and presentation components defined by respective experts, wherein the data provider component acquires data, the processor component enhances data for usability, and the presentation component displays data.

11. The system of claim 10, the composition component is configured to compose the platform independent dashboard as a function of a declaration of composition.

12. The system of claim 10, the processor component is configured to provide domain-specific data enhancement functionality.

13. The system of claim 10, the data provider component is configured to augment a query specified over a data source based on input from the processor component.

14. The system of claim 10, the composition component is configured to compose a domain specific dashboard.

15. The system of claim 10 further comprises an update component configured to make additional pre-defined data provider, processor, or presentation components available.

16. The system of claim 10, at least one of the data provider, processor, and presentation components is configured to enable configuration thereof as a function of one or more end-user preferences.

17. The system of claim 10, the composition component is configured to compose a dashboard with dependent components that vary as a function of user interaction.

18. A computer-readable storage medium having data stored thereon comprising:
a data provider component configured to acquire data from a source;
a processor component configured to enhance data; and
a presentation component configured to visualize data,
wherein the data provider component, the processor component, and the presentation component are loosely coupled components that together implement a user interface.

19. The computer-readable storage medium of claim 18, the data provider component is configured to augment a query provided to the source based in input from the processor component.

20. The computer-readable storage medium of claim 18, at least one of the data provider component, the processor component, and the presentation component is configured to enable configuration in accordance with one or more end-user preferences.
